(19) United States
(12) Patent Application Publication
(10) Pub. No.: US 2019/0313622 A1
(43) Pub. Date: Oct. 17, 2019

(54) WATER TANK FIXED ACOUSTIC MOSQUITO LARVAE KILLER

(71) Applicant: Herbert Joseph Nyberg, Old Lyme, CT (US)

(72) Inventor: Herbert Joseph Nyberg, Old Lyme, CT (US)

(21) Appl. No.: 16/302,807

(22) PCT Filed: May 22, 2017
(86) PCT No.: PCT/US2017/033775

§ 371 Date: Nov. 19, 2018

Related U.S. Application Data
(60) Provisional application No. 62/339,237, filed on May 20, 2016.

(51) Int. Cl. A01M 1/22; G10K 11/00

(52) U.S. Cl. CPC A01M 1/226; A01M 2200/01; G10K 11/006

(57) ABSTRACT

An apparatus for killing mosquito larvae in a water tank, comprising: a float; a transmitter of acoustic energy, wherein the transmitter is fixed to the float; an extension arm pivotably connected at one end to the float and having a pivotable connection for securing to a water tank at the other end; and an amplifier and controller mechanism for causing the transmitter to emit pulses of acoustic energy, wherein the amplifier/controller is operatively connected to the transmitter and has a power source.

### BACKGROUND OF THE INVENTION

Mosquito infestations carrying significant diseases have increased dramatically in tropical zones. The rapid urbanization of many areas has caused numerous mosquito borne disease epidemics. A significant factor in this is the need to locally store water in large containers, cisterns, caixa d′agua, wells and the like. These are excellent breeding habitats for many species including Aedes, a day flying and biting mosquito that carries Dengue, Chickungunya, Yellow Fever, Zika and others. It has been shown that water tanks in Brazil contribute 40% to the Dengue burden alone. Since these tanks are for potable water, chemical pesticides cannot be used.

### SUMMARY OF THE INVENTION

Acoustic Larvicide™ has been proven effective in portable systems. This is where acoustic energy is introduced into the water at resonance with the dorsal tracheal trunk of mosquito larvae causing it to rupture, which instantly kills the larvae. This novel approach is a low cost permanent solution with a number of new inventions to make it practical for use. U.S. Pat. No. 6,298,011 by Nyberg is drawn to a method for killing mosquito larvae, and is incorporated herein by reference.

Mosquito larvae tend to rest on the surface of the water. The water level in these tanks routinely varies. Energy has to be optimized for this behavior. Use of a float attached to a double articulating extendable arm is a unique way to position an acoustic source for killing mosquito larvae in a tank. The use of a short height radial transducer develops a horizontal toroid acoustic beam pattern keeping all sound energy near the surface and not wasting energy in the lower water volume. However, this transducer needs to be kept level as the water depth changes and the extension arm changes hanging angle. This is accomplished by our novel double articulation action. The extension arm can be telescoping to accommodate the various sizes of tanks that can be utilized. Coiled wire is to keep the wire from becoming immersed in the water possibly causing contamination to the water, while being able to accommodate various extension lengths of the extension rod.

According to the invention, novel activation protocol is also provided. This economizes the use of power in addition to the above mentioned acoustic beam pattern. Pulses can be set to only activate in periodic bursts as opposed to continuous or simi-continuous activation. Taking advantage of the resting position of the larvae and a random ultra-short pulse, this scheme has proven to kill 100% of larvae in a 3 m by 3 m tank in 24 hours, thus assuring 100% continuous ongoing control.

### BRIEF DESCRIPTION OF THE DRAWINGS

A detailed description of preferred embodiments of the invention follows, with reference to the attached drawings, wherein:

FIG. 1 is a schematic illustration of a system according to the invention;

FIG. 2 illustrates an apparatus according to the present invention;

FIG. 3 shows a typical environment of use for the system in accordance to the present invention.

### DETAILED DESCRIPTION

The invention relates to a water tank fixed acoustic mosquito larvae killer. In accordance with the present invention, this system is fixed to a water tank for holding standing water such as water storage tanks as described above, and is adapted to kill mosquito larvae in a highly effective manner regardless of the fact that the water level in such tanks can vary.

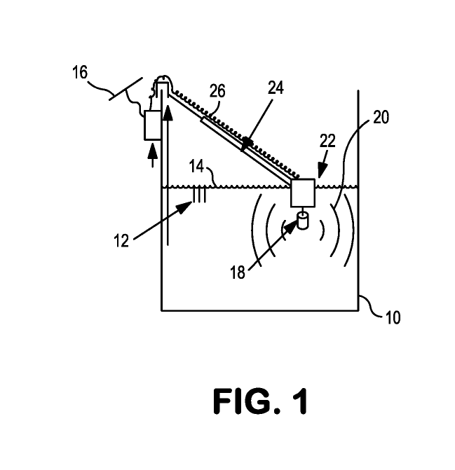

FIG. 1 shows a water tank 10 with mosquito larvae 12 present at the surface 14 of water in the water tank.

A power source such as a solar panel 16 as shown in FIG. 1 or other domestic power supply is connected to an acoustic transmitter 18 of acoustic energy 20, and this acoustic energy is introduced into the water in the tank at a resonance with the dorsal tracheal trunk of mosquito larvae to kill the larvae in accordance with the teachings of U.S. Pat. No. 6,298,011. As described in the aforesaid patent, this resonance ruptures the dorsal tracheal trunk of mosquito larvae, which kills the larvae.

In accordance with the invention as shown in FIG. 1, in order to accommodate the fact that mosquito larvae tend to rest on the surface of the water, and the level of water in a particular tank can change, the transmitter is mounted to a float 22 as shown in FIG. 1, and this float suspends the transmitter 18 at the proper height within the water such that toroidal acoustic beam patterns can keep the acoustic energy and sound near the surface of the water, where it is effective to kill mosquito larvae.

In order to connect the power source 16, which can be mounted to the tank 10, to the float and transmitter, a double articulated telescoping extension arm 24 can be connected from the tank and/or power source to the float and/or transmitter. A coiled wire 26 or other conduit for carrying energy from power source to the transmitter can be disposed along the telescoping extension arm. In this way, as water level increases or decreases in the tank, the extension arm can adjust to the proper distance from the first articulated or pivot point of the arm to the float, and the coiled wire carried by the telescoping extension arm adjusts to the length as well.

This configuration advantageously positions the transmitter at the appropriate water level regardless of changes in the water level, such that acoustic energy generated by the transmitter is highly effective in killing mosquito larvae at the surface.

The power source can be a solar panel as illustrated, as this can keep the apparatus functioning regardless of potentially remote areas in which the device is located. Alternatively, the device can also be connected to domestic power. Further, an amplifier/controller 27 can be operatively associated with the power source and the amplifier and be programmed to cause the transmitter to emit acoustic energy as desired.

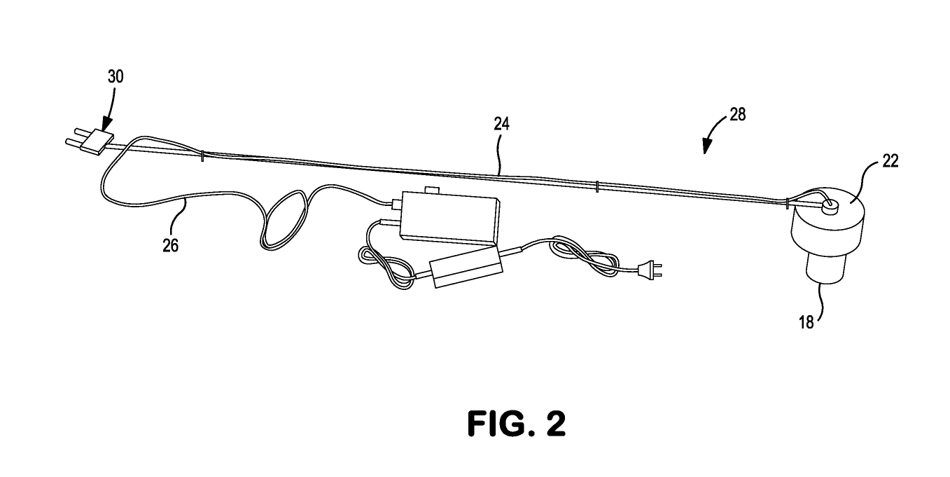

FIG. 2 shows an apparatus 28 according to the invention having a double-articulated telescoping extension arm 24 connected between a float 22 at one end having the transmitter 18, and a structure 30 for mounting to the tank at the other end. In addition, coiled wire 26 is connected from the transmitter 18 along the arm to the control and power source for the device. Of course, modifications to this particular design can be made as would be understood by a person of ordinary skill in the art, well within the scope of the present invention.

Arm 24, by being double-articulated, can pivot relative to the tank wall and also the float or transmitter to maintain proper orientation at different water levels. The telescoping structure helps with this orientation by allowing length of the arm to adjust at different positions.

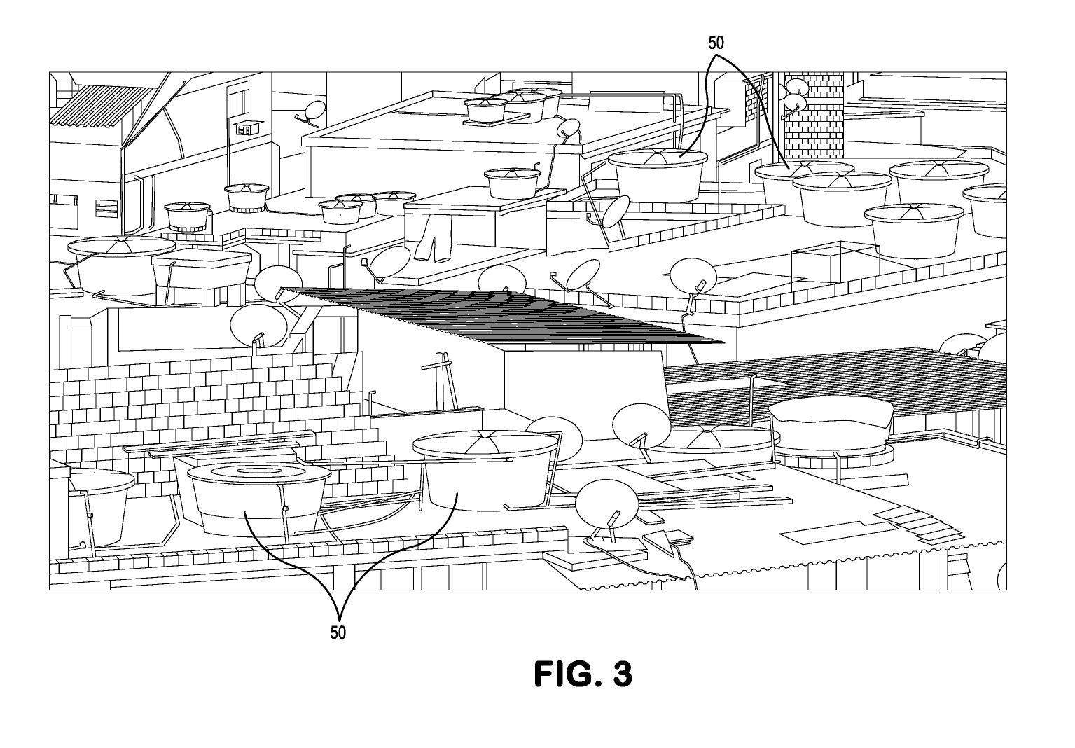

FIG. 3 shows a typical environment of use for the apparatus of the present invention, wherein many storage tanks are disposed on rooftops in residential areas where breeding grounds form for mosquitos, in heavily populated areas. In accordance with the present invention, a system deployed in a tank such as those shown in FIG. 3 can be used to establish a 100% kill rate of larvae in the tank, with no contamination of the water in the tank, and potentially using energy supplied solely from a solar panel. It should be readily apparent that this is an advantageous and highly desirable development.

Activation protocol to minimize power use. 3 milisecond pulse every 6 hours. Using limited frequency band. Normally in natural environment all frequencies corresponding to the various size mosquito larvae must be used. In fixed tank at some point the mosquito larvae size will fall within our shorter acoustic band resulting in the same lethality but at much reduced power requirements. Two novel ideas non continuous operation taking advantage of the extended time mosquito larvae will spend on the surface and the high probability they will be in our narrow toroidal beam pattern and second more narrow bandwidth of sound as compared natural environment.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

1. An apparatus for killing mosquito larvae in a water tank, comprising:
a float;
a transmitter of acoustic energy, wherein the transmitter is fixed to the float;
an extension arm pivotably connected at one end to the float and having a pivotable connection for securing to a water tank at the other end; and
an amplifier and controller mechanism for causing the transmitter to emit pulses of acoustic energy, wherein the amplifier/controller is operatively connected to the transmitter and has a power source.

2. The apparatus of claim 1, wherein the extension arm is a telescoping extension arm.

3. The apparatus of claim 1, wherein the power source is a solar panel.

4. The apparatus of claim 1, wherein the extension arm is double-articulating wherein the transmitter is maintained at a surface of water in the water tank and in a vertical orientation to maintain a horizontal toroid acoustic pattern.

5. The apparatus of claim 1, further comprising a coiled wire to allow full extension of the arm without the coiled wire touching water.
